(19) United States
(12) Patent Application Publication
(10) Pub. No.: US 2007/0248727 A1
(43) Pub. Date: Oct. 25, 2007

(54) Method for Removing Hydrohydroquinone

(75) Inventors: Atsushi Konishi, Sumida-ku (JP); Hirokazu Takahashi, Sumida-ku (JP); Eri Itaya, Sumida-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KAO CORPORATION, Tokyo (JP)

(21) Appl. No.: 11/574,621

(22) PCT Filed: Sep. 20, 2005
(86) PCT No.: PCT/JP05/17295

§ 371 Date: Mar. 2, 2007

(30) Foreign Application Priority Data
Sep. 21, 2004 (JP) 2004-273244
Aug. 3, 2005 (JP) 2005-225792

(51) Int. Cl. C12H 1/04

(52) U.S. Cl. 426/423

(57) ABSTRACT

The present invention relates to a method of removing hydroxyhydroquinone from an aqueous solution containing hydroxyhydroquinone and caffeoylquinic acids by bringing the aqueous solution into contact with an acid clay having a SiO₂/Al₂O₃ ratio of from 3 to 5. The present invention enables selective removal of hydroxyhydroquinone from an aqueous solution containing hydroxyhydroquinone and caffeoylquinic acids.

### FIELD OF THE INVENTION

The present invention relates to a method for selectively removing hydroxyhydroquinone from an aqueous solution.

### BACKGROUND OF THE INVENTION

Hydrogen peroxide, known as a radical oxygen, is said to be deeply associated with many diseases including circulatory diseases such as arteriosclerosis and ischemic heart disease, gastrointestinal diseases, allergic diseases and eye diseases, as well as mutagenicity and carcinogenicity (Non-patent Document 1). Coffee contains hydrogen peroxide which is generated spontaneously by roasting (Non-patent Document 2). A technology of removing hydrogen peroxide from coffee by the addition of a catalase, a peroxidase, an antioxidant or the like (Patent Documents 1 to 4) has been reported.

[Non-patent Document 1] Japanese Journal of Nutritional Assessment, 19, 3(2002)

[Non-patent Document 2] Mutat. Res. 16, 308(2) (1994)

[Patent Document 1] JP-B-04-29326

[Patent Document 2] JP-A-03-127950

[Patent Document 3] JP-A-11-266842

[Patent Document 4] JP-A-2003-81824

### DISCLOSURE OF THE INVENTION

The present invention relates to a method of removing hydroxyhydroquinone from an aqueous solution containing hydroxyhydroquinone and caffeoylquinic acids, which includes bringing the aqueous solution into contact with an acid clay having a SiO₂/Al₂O₃ ratio of from 3 to 5.

The present invention also relates to an aqueous solution containing caffeoylquinic acids, which solution is available by the above-described method and has a (hydroxyhydroquinone/caffeoylquinic acids) mass ratio of from 0 to 0.005.

### MODE FOR CARRYING OUT THE INVENTION

It has been found out that when coffee from which hydrogen peroxide had been removed was given to rats, their urinary hydrogen peroxide level increased owing to the generation of hydrogen peroxide in their bodies. It has further been found out that the generation of hydrogen peroxide in the bodies is caused by hydroxyhydroquinone contained in the coffee. It is therefore desired to remove hydroxyhydroquinone from coffee.

Since coffee contains caffeoylquinic acids exhibiting an excellent hypotensive effect, a reduction in the amount of such an effective component during the step of removing hydrogen peroxide or hydroxyhydroquinone is not desired. There is therefore a demand for the development of a technology capable of selectively removing hydroxyhydroquinone from coffee while minimizing the reduction in the amount of caffeoylquinic acids therein.

The present invention provides a method of selectively removing hydroxyhydroquinone from an aqueous solution containing hydroxyhydroquinone and caffeoylquinic acids.

The present inventors have therefore carried out an investigation on a method of selectively removing hydroxyhydroquinone from an aqueous solution containing hydroxyhydroquinone and caffeoylquinic acids. As a result, it has been found that the above-described benefit can be achieved by bringing the aqueous solution into contact with a specific acid clay.

According to the present invention, by bringing an aqueous solution containing hydroxyhydroquinone and caffeoylquinic acids into contact with a specific acid clay, hydroxyhydroquinone can be removed conveniently without causing a substantial reduction in the caffeoylquinic acid content. This method is useful as a manufacturing method of healthy foods and the like.

No particular limitation is imposed on the aqueous solution containing hydroxyhydroquinone and caffeoylquinic acids and examples thereof include coffee such as Brazilian coffee, Columbian coffee, Tanzanian coffee and Mocha coffee. There are mainly two coffee species, that is, Arabica species and Robusta species. For the preparation of coffee, either a single type of beans or a blend of several types of beans may be used. Although no particular limitation is imposed on the roasting method for the preparation of roasted coffee beans and no particular limitation is imposed on the roasting temperature or roasting environment, the L value, which represents the degree of roast, is preferably 18 or greater, more preferably 20 or greater, even more preferably from 22 to 30. There is no limitation on the extracting method from beans. An extract is available by extraction with warm water, preferably with hot water. As an extracting operation, conventionally known extraction processes such as batch extraction and continuous extraction using a column may be employed as typically used.

Examples of the caffeoylquinic acids which may be removed by the present invention include 3-caffeoylquinic acid, 4-caffeoylquinic acid, 5-caffeoylquinic acid, 3,4-dicaffeoylquinic acid, 4,5-dicaffeoylquinic acid and 3,5-dicaffeoylquinic acid and salts thereof.

The concentration of caffeoylquinic acids in an aqueous solution, such as coffee, containing hydroxyhydroquinone and caffeoylquinic acids is preferably from 0.01 to 2 mass %, more preferably, from 0.03 to 1 mass %, even more preferably from 0.06 to 0.5 mass %.

When the aqueous solution was brought into contact with an ordinarily used white clay other than the white clay preferably used in the present invention, not only hydroxyhydroquinone but also the caffeoylquinic acids were inevitably adsorbed to it and selective removal of hydroxyhydroquinone was not accomplished. The acid clay to be used in the present invention is a naturally produced acid clay (montmorillonite clay) having a porous structure with a large specific surface area and adsorption capacity. The acid clay preferably contains, as general chemical components, SiO₂, Al₁₂O₃, Fe₂O₃, CaO and MgO. When it is used in the present invention, its SiO₂/Al₂O₃ ratio ranges from 3 to 5, preferably from 4 to 5 (as a mass ratio of a dried product at 110° C.), its specific surface area is preferably from 50 to 350 m²/g, and its pH (as a 5% suspension) preferably ranges from 5 to 10, more preferably from 6 to 9.8, even more preferably from 7 to 9.4. The aqueous solution containing hydroxyhydroquinone and caffeoylquinic acids can be brought into contact with the acid clay by any method, for example, batch treatment and continuous treatment using a column.

The commonly employed method is to add the acid clay in a powder form to the aqueous solution, stir the mixture to adsorb the hydroxyhydroquinone to the clay, and perform a filtering operation to obtain a filtrate from which the hydroxyhydroquinone has been removed; or to carry out continuous treatment using a column filled with the acid clay in a granular form, thereby adsorbing hydroxyhydroquinone thereto. Conditions of the above-described treatment can be selected as needed depending on the kind of the aqueous solution containing caffeoylquinic acids and hydroxyhydroquinone or the concentration of the extract. When the continuous treatment using a column is employed, removal can be accomplished by feeding about 1 to 100 volumes of the aqueous solution containing caffeoylquinic acids and hydroxyhydroquinone to 1 volume of the acid clay in the granular form. The solution which has passed through the column to remove hydroxyhydroquinone can also be converted into a solid such as a powder or granule by drying it in a known manner such as spray drying, freeze drying or hot air drying as is or after concentrating it under reduced or normal pressure. The operation in the present invention may be conducted within a range of room temperature, preferably, from 10 to 40° C.

The amount of hydroxyhydroquinone which remains in the aqueous solution containing caffeoylquinic acids obtained in the above-described manner is preferably from 0 to 0.005, especially preferably from 0 to 0.001 (mass ratio) in terms of a (hydroxyhydroquinone/caffeoylquinic acids) ratio in order to avoid suppression of a hypotensive effect of caffeoylquinic acids by hydroxyhydroquinone.

For example, a (hydroxyhydroquinone/caffeoylquinic acids) ratio of the aqueous solution ranging from about 0.01 to 1 (mass ratio) is reduced to a (hydroxyhydroquinone/caffeoylquinic acids) ratio ranging from about 0 to 0.005 by the removal treatment according to the present invention. A reduction in the concentration of caffeoylquinic acids in the whole composition by this removal treatment is small. Accordingly, the present invention makes it possible to selectively remove hydroxyhydroquinone, which is a causative factor of hydrogen peroxide generation in the living body, without impairing the physiological effects of caffeoylquinic acids such as a hypotensive effect.

### EXAMPLES

### Referential Example 1

### Evaluation on Hypotensive Effect

An evaluation test was performed after the blood pressure of each of 12-week-old male spontaneously hypertensive rats (SHR) was preliminarily measured for five straight days by using a commercially available noninvasive sphygmomanometer for rats (manufactured by Softron Co., Ltd.) in order to accustom the rats to the sphygmomanometric operation. These rats were all bred under conditions (breeding room in a rat region) of room temperature at 25±1° C., relative humidity of 55±10% and illumination for 12 hours (from 7:00 am to 7:00 pm).

A fraction obtained by removing hydroxyhydroquinone from instant coffee was orally administered to a test group, while instant coffee was orally administered to a control group. Systolic blood pressures of the caudal vein were measured prior to oral administration and 12 hours after administration and based on them, the percent change in blood pressure from the prior to oral administration to that after 12 hours was calculated. As a result, it was recognized that the rats to which the hydroxyhydroquinone-free instant coffee had been administered showed a marked decrease in blood pressure compared with those to which instant coffee had been administered without such treatment.

### Referential Example 2

### (1) Preparation of Coffee

After 14.0 g of instant coffee was dissolved uniformly in warm water to provide a total amount of 1000 g, the resulting solution was cooled to prepare 1000 g of a coffee extract.

### (2) Analysis Method of Caffeoylquinic Acid (CQA)

The caffeoylquinic acid content in the composition is analyzed in the below-described manner. HPLC was employed as an analytical instrument.

Model Number of Units Constituting the Instrument

Detector: L-7420 (product of Hitachi, Ltd.), oven: MODEL 554 (product of GL Sciences), pump: L-7100 (product of Hitachi, Ltd.), autosampler: L-7200 (product of Hitachi, Ltd.), interface: D-7000 (product of Hitachi, Ltd.), column: Inertsil ODS-2, 2.1 mm in inner diameter×250 mm in length (product of GL Sciences).

Analysis Conditions

Sample injection amount: 10 μL, flow rate: 0.3 mL/min, detection wavelength of UV absorptiometer: 325 nm (caffeoylquinic acids), eluent A: a 3 vol % acetonitrile solution containing 0.05M acetic acid (2.86 mL of acetic acid/970 mL of distilled water/30 mL of acetonitrile (v/v/v), eluent B: a 100 vol % acetonitrile solution containing 0.05M acetic acid (2.86 mL of acetic acid/1000 mL of acetonitrile (v/v)).

Concentration Gradient Conditions

| Time | Eluent A | Eluent B |
|---|---|---|
| 0 minute | 100% | 0% |
| 20 minutes | 80% | 20% |
| 35 minutes | 80% | 20% |
| 45 minutes | 0% | 100% |
| 60 minutes | 0% | 100% |
| 70 minutes | 100% | 0% |
| 120 minutes | 100% | 0% |

The Retention Time of Caffeoylquinic Acids (unit: minute)
(A¹) Monocaffeoylquinic acid: Three points in total of 17.9, 20.4 and 22.0
(A²) Dicaffeoylquinic acid: Three points in total of 32.3, 33.0 and 35.8. From the area determined here, the caffeoylquinic acid content (mass %) was determined using 5-caffeoylquinic acid as a standard substance.

### (b 3) Analysis Method of Hydroxyhydroquinone (HHQ)

The hydroxyhydroquinone content in the composition was analyzed in the below-described manner. HPLC was employed as an analytical instrument.

Model Number of Units Constituting the Instrument

Detector: L-7420 (product of Hitachi, Ltd.), oven: MODEL 554 (product of GL Sciences), pump: L-7100 (product of Hitachi, Ltd.), autosampler: L-7200 (product of Hitachi, Ltd.), interface: D-7000 (product of Hitachi, Ltd.), column: Inertsil ODS-2, 4.6 mm in inner diameter×250 mm in length (product of GL Sciences).

Analysis Conditions

Sample injection amount: 30 μL, flow rate: 1.0 mL/min, detection wavelength of UV absorptiometer: 288 nm (hydroxyhydroquinone), eluent A: a 0.05M acetic acid aqueous solution (2.86 mL of acetic acid/1000 mL of distilled water (v/v)), eluent B: a 0.05M acetic acid acetonitrile solution (2.86 mL of acetic acid/1000 mL of acetonitrile (v/v)).

Concentration Gradient Conditions

| Time | Eluent A | Eluent B |
|---|---|---|
| 0 minute | 100% | 0% |
| 15 minutes | 100% | 0% |
| 25 minutes | 0% | 100% |
| 30 minutes | 0% | 100% |
| 40 minutes | 100% | 0% |
| 50 minutes | 100% | 0% |

The Retention Time of Hydroxyhydroquinone (Unit:Minute) 6.5 minutes. From the area determined here, the hydroxyhydroquinone content (mass %) was determined using hydroxyhydroquinone as a standard substance.

### Referential Example 3

In a similar manner to Referential Example 2, 14.0 g of instant coffee was dissolved uniformly in warm water to provide a total amount of 1000 g, followed by cooling to prepare 1000 g of a coffee extract. Analysis of caffeoylquinic acid (CQA) and analysis of hydroxyhydroquinone (HHQ) were conducted as in Referential Example 1.

### Referential Example 4

Coffee beans of two Robusta species different in the degree of roast (L values: 16 and 22) were ground and then coffee extracts were prepared respectively in the conventional manner. The caffeoylquinic acid (CQA) and hydroxyhydroquinone (HHQ) concentrations in each of the resulting coffee extracts were analyzed in accordance with the method as described in Referential Examples 2 and 3.

TABLE 1

| Degree of roast | Components | Concentration (mg/mL) | HHQ/CQA |
|---|---|---|---|
| L = 22 | CQA | 1.0761 | 0.0150 |
| | HHQ | 0.0161 | |
| L = 16 | CQA | 0.1742 | 0.1191 |
| | HHQ | 0.0207 | |

It is understood from Table 1 that the (hydroxyhydroquinone/caffeoylquinic acids) ratio of the coffee extract having the degree of roast L of 22 is lower than that of the coffee extract having the degree of roast L of 16.

### EXAMPLE 1

A white-clay treated solution 1 was obtained by bringing 14.0 g of an acid clay (“Mizuka Ace #200”, a 5% suspension having pH 7.6) having a SiO₂/Al₂O₃ ratio of 4.9 into contact with 200 g of the coffee extract obtained by the operation of Referential Example 1 at room temperature for 30 minutes, and then removing the acid clay by filtration under reduced pressure.

White-clay treated solutions 2, 3 and 4 were then obtained, respectively, by bringing 14.0% g of acid clays having a SiO₂/Al₂O₃ ratio of 4.3, 4.8 and 5.0 into contact with 200 g of the coffee extract obtained by the operation of Referential Example 1 at room temperature for 30 minutes, and then removing the acid clays by filtration under reduced pressure.

At the same time, the amounts of caffeoylquinic acids (CQA) and hydroxyhydroquinone (HHQ) in each of the solutions obtained above were analyzed as in Referential Example 1.

### COMPARATIVE EXAMPLE 1

Comparative treated-solutions 1 and 2 were prepared, respectively, by bringing acid clays having a SiO₂/Al₂O₃ ratio of 9.2 and 6.8 (their pHs, as a 5% suspension: 3.4 and 3.6, respectively) into contact with 200 g of the coffee extract obtained by the operation of Referential Example 2 at room temperature for 30 minutes, and then removing the acid clays by filtration under reduced pressure. At the same time, the amounts of caffeoylquinic acids (CQA) and hydroxyhydroquinone (HHQ) were analyzed as in Referential Example 1.

TABLE 2

| | Amount of | SiO₂/ | HHQ | CQA | HHQ/ |
|---|---|---|---|---|---|
| | white clay | Al₂O₃ | (mass %) | (mass %) | CQA |
| Referential | None | — | 0.0104 | 0.4849 | 0.0214 |
| Example 1 | | | | | |
| White-clay | 7.0% | 4.9 | 0 | 0.4424 | 0.0000 |
| treated solution 1 | | | | | |
| White-clay | 7.0% | 4.8 | 0.0002 | 0.4627 | 0.0004 |
| treated solution 2 | | | | | |
| White-clay | 7.0% | 4.3 | 0.0002 | 0.4670 | 0.0004 |
| treated solution 3 | | | | | |
| White-clay | 7.0% | 5.0 | 0.0017 | 0.3971 | 0.0042 |
| treated solution 4 | | | | | |
| Referential | None | — | 0.0157 | 0.5172 | 0.0304 |
| Example 2 | | | | | |
| Comparative | 7.0% | 9.2 | 0.0045 | 0.4586 | 0.0099 |
| treated-solution 1 | | | | | |
| Comparative | 7.0% | 6.8 | 0.0042 | 0.4996 | 0.0085 |
| treated-solution 2 | | | | | |

SiO₂/Al₂O₃ ratio: mass ratio after drying at 110° C.

It was found from Table 2 that when the acid clay having a SiO₂/Al₂O₃ ratio of from 3 to 5 was used, a reduction in the concentration of caffeoylquinic acids is small and only hydroxyhydroquinone can be removed selectively. It was also found that when the acid clay having a SiO₂/Al₂O₃ ratio exceeding 5 is used, on the other hand, a removal ratio of hydroxyhydroquinone is inferior.

1. A method of removing hydroxyhydroquinone from an aqueous solution containing hydroxyhydroquinone and caffeoylquinic acids, comprising the step of bringing the aqueous solution into contact with an acid clay having a SiO₂/Al₂O₃ ratio of from 3 to 5.

2. The method of removing hydroxyhydroquinone according to claim 1, wherein the aqueous solution containing hydroxyhydroquinone and caffeoylquinic acids is a coffee bean extract having a degree of roast (L value) of 18 or greater.

3. A caffeoylquinic-acid-containing aqueous solution having a hydroxyhydroquinone/caffeoylquinic acids mass ratio of from 0 to 0.005, which is provided by the method as claimed in claim 1 or 2.
